(19) United States
(12) Patent Application Publication
(10) Pub. No.: US 2004/0126594 A1
(43) Pub. Date: Jul. 1, 2004

(54) Surface coating for a collector tube of a linear parabolic solar concentrator

(76) Inventors: Carlo Rubbia, Geneve (CH); Alessandro Antonaia, Portici (IT); Salvatore Esposito, Portici (IT)

Correspondence Address: Jay A. Bondell, Esq., SCHWEITZER CORNMAN GROSS & BONDELL LLP, 292 Madison Avenue, New York, NY, 10017, US

(21) Appl. No.: 10/720,427

(22) Filed: Nov. 24, 2003

Related U.S. Application Data
(63) Continuation of application No. PCT/IT02/00372, filed on Jun. 6, 2002.

(51) Int. Cl. B32B 9/04

(52) U.S. Cl. 428/446

(57) ABSTRACT

A surface coating material for heat collector elements (HCE) of solar plants, is a multi-layer structure comprising a lower infrared-reflecting metal layer, an upper layer of a non-reflecting material, and an intermediate layer of a composite ceramic-metallic (CERMET) material having upper and lower layers of different volumetric metal fractions. The lower layer has a volumetric metal fraction higher than that of the upper CERMET layer. The ceramic matrix of the CERMET is formed by amorphous silicon dioxide (SiO₂). The reflecting metal layer has a thickness ranging from 90 to 110 nm. The lower CERMET layer has a thickness ranging from 70 to 80 nm and a volumetric metal fraction in the range from 0.45 to 0.55. The upper CERMET layer has a thickness ranging from 70 to 80 nm and volumetric metal fraction ranging from 0.15 to 0.25. The layer of anti-reflecting material layer has a thickness ranging from 65 to 75 nm.

The present application is a continuation of PCT/IT02/00372

The present invention relates to solar power plants for the production of energy, and particularly to a novel material to be used as a surface coating or coating for a heat collector element (HCE) of a solar plant, preferably of the kind with linear parabolic mirrors, able to operate at high temperatures.

### BACKGROUND OF THE INVENTION

Presently, materials suitable for use as surface coatings of a solar HCE are those which behave in a selective manner with respect of the incident radiation. That is, the materials have optic properties of reflection, absorption and hemispheric emission that change according to the wavelength of the radiation ranging from the radiation zone of the solar spectrum to the thermal infrared zone. The coating to be is formed should have a behaviour near as possible to an ideal, that is with a reflectivity=0 (unitary absorptivity) in the spectrum zone of solar radiation, defined as a radiation zone of up to 1.7 μm wavelengths shown as at the left side region in FIG. 2, and a unitary reflectivity (emissivity=0) in the zone of the thermal infrared, with a step transition between the zones.

The materials which are generally used as solar absorbers are porous metals, degenerated semiconductors and “CERMETS”, which are composite ceramic-metallic materials in which metal particles are dispersed in a ceramic matrix.

Particularly, CERMETS are materials which fulfil the above requirements by having a high absorption peak in the solar spectrum zone and a low emissivity in the thermal infrared zone. The interest for these composite materials arose in 1950, when Tabor, Gier and Dunkle presented their first results about the use of CERMETS as coating materials for the selective absorption of solar radiation. Successively, the selective absorption characteristics of several composite materials have been studied, among which Cu, Ni, Co, Pt, Cr, Mo, W, Al and Ag were the commonly employed metallic materials, whereas the ceramic matrix was mainly formed by SiO, SiO₂, Al₂O₃, A N and MgO. Some of these materials have been principally commercialised in power generating plants (from few KW to some tens MW).

The first composite materials utilized as selective absorbers were formed with a layer of CERMET having a homogeneous volumetric metal fraction, inserted between a metal layer, operating as an infrared reflector, and a layer of antireflection material allowing an improvement of the absorption of the solar spectrum. T. S. Sathiaray, et al. have deposited, on a substrate of Mo, 70 nm of Ni-Al₂O₃ CERMET having a Ni volumetric fraction of 0.21 and have covered it with 60 nm of antireflective SiO_{2.} This structure presented an absorption of 0.87 and an emissivity 0.07 at 100° C. Similar structures have been realized and it has been possible from time to time to decrease emissivity at a cost of lower values of absorption, or to improve the absorption at a cost of higher values of emissivity.

In any case, the absorption values attained by such structures are not sufficiently high to being used for the realization of the coating materials for thermoelectric appliances; furthermore, when the operating temperature increased over 300° C., the emissivity drastically increased causing a degradation of coating performance.

Successive, studies have been performed with respect to coatings with more complex structures, in attempts to reach absorptions higher than 0.9 and emissivities as low as possible at high temperatures.

The first structure, which was studied and realized, was with a variable metal content dispersed in the ceramic matrix. Several works performed from 1977 presented the advantages attained by inserting between the metal reflector and the antireflection layer a CERMET having a metal volumetric fraction decreasing from the metal reflector to the antireflection layer.

Studies made in these years by I. T. Ritche and B. Window have evidenced that among several possible profiles disclosing the metal content in the ceramic matrix, the linear one maximized solar absorption.

Studies which followed, including those by Qi-Chu Zhang, evidenced that these kinds of materials, even if they presented the highest possible absorption, exhibited an emissivity which quickly increased with the increase of temperature. This increase was due to two kinds of effects: the superimposition of wavelengths of the solar spectrum on the spectrum re-irradiated from the coating, which increased with an increase in temperature; and the selectivity of the continuously variable profile structure, which was not as evident at the passage from the low reflectivity zone in the solar spectrum to the high reflectivity zone. For obviating this behavior at the high temperature of the continuously variable profile CERMET, Qi-Chu Zhang suggested an alternative structure consisting of a series of superimposed CERMET layers, each with a different metal volume fraction, inserted between a metallic reflector and an antireflection layer. By a suitable selection of the metal volumetric percentages in the CERMET layers it was possible to modify the selective properties of the coating by displacing the transition between the high reflectivity zone and the low reflectivity zone, so as to result in a continuously variable linear profile structures by modifying the slop of the profile. Particularly, Qi-Chu Zhang suggested to realize the coating preferably by increasing the metal volumetric fraction from the layer contacting the metal toward that contacting the antireflection layer.

Finally, by properly selecting the thickness of the layer it was possible to attain a sharper transition between low reflectivity in the solar spectrum and high reflectivity in the infrared by exploiting the beneficial effects of interference among the signals reflected from the several layers. Thus, notwithstanding that such a structure was not able to give absorption values comparable with those of the continuously variable profile structure, it was able to provide performance improving with an increase of the operating temperature of the coating.

Until to today both structures, i.e. that with a multi-layer CERMET and that with a continuously varying profile, have been employed in the commercial sector for the realization of domestic and industrial systems for air-conditioning, for energy production and for desalination of salt water. It should be noted that, in general, the working temperature of the coatings does not exceed 400° C., so that the performance of the systems are comparable with each other, independent of the structure used as the coating.

Presently, among the companies engaged in the production of solar collectors for high temperature, and thus suitable for use for power generation, are the Israeli Company SOLEL Solar Systems (previously Luz International Limited) and the Chinese company TurboSun Energy Company. The technical approaches of these two Companies are wholly different from the point of view of collector construction, but above all, from the point of view of the kind of CERMET employed.

The Israeli company, having a twenty-year experience developed through US plants, has concentrated its research and production efforts on the continuously variable profile CERMET; the recent evolution of a collector for linear concentration plants (LS-3) uses a Mo-AI₂O₃ CERMET. The absorption and emission values supplied by SOLEL are respectively 0.97 and 0.08 at 400° C. (the working temperature is anyway indicated as equal to 380° C.). As to the Chinese company, the development line of their products relates to the use of two layer CERMETS, developed in cooperation with the Universities of Peking and Sydney. The product presently in commerce is a CERMET formed by A1N-SS (Stainless steel)/Cu, the operating characteristics of which, as supplied by the company, are 0.94-0.96 as to the absorptivity, whereas as to emissivity a value lower than 0.10 at 350° C. is indicated.

As it clearly results from the analysis just now performed, one of the greatest limits of the CERMET coatings as presently known is the value of the maximum temperature at which they may work with good performance. A useful parameter for comparing the performances of solar concentrators of thermoelectric plants is the photo-thermal conversion efficiency (ηₚₜ):

$${η}_{p t} = α - {ϵ}_{h} \frac{σ {T}^{2}}{C I}$$

wherein α is the absorptivity, εₕ is the emissivity, σ is the Stefan-Boltzmann constant, T is the temperature of the coating, I is the irradiativity of the direct component of the solar spectrum calculated at AM 1.5, and C is the concentration factor (span of the mirror/circumference of the collector). The photo-thermal conversion efficiency has been used as a parameter for comparing the performances of commercial products at the 400° C. temperature for which they are designed and at 580° C. In this comparison, the efficiency has been calculated with a concentration factor of 26, typical for linear parabolic mirror plants. The commercial coatings which have been examined are two: the first one realized with a continuously variable profile CERMET layer and the second one realized with two homogeneous CERMET layers.

In both cases, with a comparison between average and high working temperatures, the conversion efficiency drastically decreased with the increase of the temperature, passing from 0.875 to 0.675 in the first case and from 0.905 to 0.715 in the second case.

### BRIEF DESCRIPTION OF THE INVENTION

The material of the coating according to the present invention is adapted for use as a coating for a solar collector which extends along the focal line of a concentrator and reaches a temperature substantially of 550° C. of the outflowing fluid.

In such conditions, the thermoelectric efficiency of the collector coated according to the invention is higher than that of the thermoelectric system as currently realized which works at lower temperatures (<400° C.) or utilizes conventional further heating of the fluid to attain an optimal working temperature.

According to the invention, the use of higher fluid temperatures allows high efficiencies of the turbine to be attained, since it is not necessary to further heat the fluid before it is input into the rotor.

For the uses, as here above disclosed, the CERMETS are more versatile and more temperature resistant materials, which assure better performance in terms of a high absorption of the solar spectrum and of a low emissivity in the infrared.

Moreover, the majority of collectors available on the market can not be employed in a thermo-electric solar plant designed for operating at a maximum temperature of 580° C., because they have problems of structural and mechanical stability. In fact, since such known collectors are designed for working at temperatures which are lower than those attained according to the invention, their mechanical and structural characteristics could be altered. Even if not altered, it would be in any case necessary to evaluate the coating properties at the new temperature conditions.

Thus, a first object of the invention is to realize a coating material for collector tubes having a high structural and mechanical stability within the entire operating temperature range, which is much higher than the working temperatures of at present known coatings, particularly between 300° C. and 580° C.

A second object of the invention is to realize a coating material of the above kind, adapted to assure a high absorptivity in the solar radiation range.

A third object of the invention is to realize a coating material of the above kind, adapted to assure a low emissivity at the maximum working temperature, preferably of 580° C., in a solar plant for power production by linear parabolic mirror technology.

A fourth object of the invention is to realize a coating material of the above kind, adapted to assure excellent performances in terms of high absorptivity and low emissivity within the whole working temperature range (300°-580° C.) along a linear collector (0-600 m

According to the invention, the foregoing objects can be realized by a multi-layer coating material, comprising a lower metal layer and an upper antireflection layer, between which two layers of composite ceramic-metal or CERMET material, with different metal volumetric fractions, are arranged. The ceramic matrix of the CERMET may consist of amorphous silicon dioxide (SiO₂) while the lower CERMET layer has a metal volumetric fraction greater than that of the upper CERMET layer.

### BRIEF DESCRIPTION OF THE DRAWINGS

The invention will be better understood from the following description of a preferred, but nonetheless illustrative, embodiment thereof further presented by way of a non-limiting example in the attached drawings, in which:

FIGS. 1A and 1B show tested structures for a coating according to the invention, respectively a variable profile CERMET and a double layer CERMET;

FIG. 2 is a diagram of the spectral reflectivity of a coating B of a variable profile CERMET and of a coating D of a double layer CERMET;

FIG. 3 is a diagram showing the spectral reflectivity of a coating C with a lower emissivity and of a coating D with a higher absorptivity, both having a double CERMET layer; and

FIG. 4 is a diagram showing the hemispheric emissivity and photo-thermal conversion efficiency of the coating D along the collector.

### DETAILED DESCRITION OF THE INVENTION

The present invention aries from the need to realize a novel material having selective proprieties at the wavelength of solar radiation, which allows it to be employed as a coating for collectors of a linear concentration system of a thermoelectric solar plant working at middle-high temperatures.

In other words, the present subject matter is a novel selective structure assuring, at a maximum working temperature of the plant of 580° C., photo-thermal conversion efficiencies higher than 0.8 for a solar concentration factor of 26.

In the research phase many metallic and ceramic materials employed in commercial systems with structural and mechanic proprieties stable at high temperatures have been investigated.

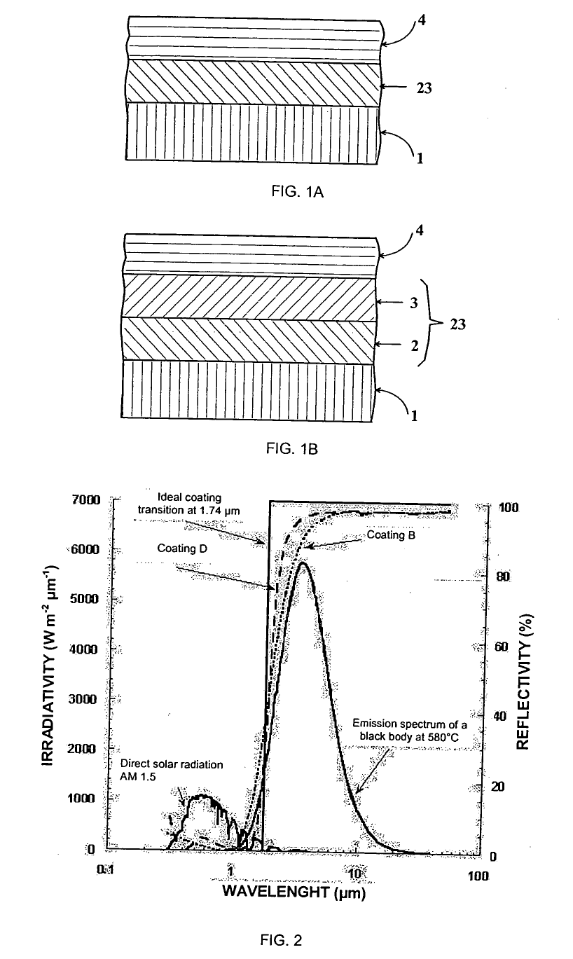

FIG. 1 shows two structural typologies tested for a coating. Both of them have a CERMET layer 23, respectively with a continuously variable profile (FIG. 1A) or with a double layer 2, 3 (FIG. 1 B), inserted between a metal layer 1 and an antireflection layer 4.

According to the invention, a double layer CERMET is preferred over a multi-layer CERMET, since research has shown that the greater structural complexity of a CERMET with more than two layers does not correspond to a real advantage in terms of performance.

The research carried out on several structures has evidenced that, among coatings of comparable performance comparable at high temperatures, those formed of molybdenum and amorphous silicon dioxide present the best combination of production costs and structural and mechanical property stability at high temperatures.

In the case of a continuously variable linear profile Mo-SiO₂ CERMET about 1200 structures have been tested; about 400,000 structures have been tested in the case of a double layer CERMET.

The following parameters have been varied in the first case:

metal layer 1 with a thickness from 100 to 150 nm;

antireflection layer 4 with a thickness from 5 to 100 nm;

continuously variable linear profile CERMET layer 23 with a thickness from 50 to 300 nm.

In the second case (double layer) the thickness of the metal has been fixed in 100 nm, whereas the following parameters have been varied:

lower CERMET layer 2 with a thickness from 40 to 80 nm;

lower CERMET layer 2 with a metal volumetric fraction from 0.3 to 0.9;

upper CERMET layer 3 with a thickness from 40 to 80 nm;

upper CERMET layer 3 with a metal volumetric fraction from 0.1 to 0.6;

antireflection layer 4 with a thickness from 40 to 80 nm.

In the optimization phase of the structure of the linear profile CERMET, there have been isolated 123 structures having a photo-thermal conversion efficiency higher than 0.78 at a temperature of 580° C. Among them, there have been selected only two structures: that having the lowest emissivity (coating A) and that having the highest absorption (coating B).

The following Table 1 shows the structural parameters of these two coatings: d indicates the thickness of the layer and ff indicates the metal volumetric fraction in the ceramic matrix.

In Table 2 there are indicated photo-thermal parameters of the two coatings at a temperature of 580° C.

The coating with a variable profile CERMET allows it to attain, at a temperature of 580° C., better performance than those of the above disclosed homologous structures available on the market, but unfortunately such a coating does not fulfill the requirement, as established in the design phase, of a photo-thermal conversion efficiency greater than 0.8.

TABLE 1

| | | CERMET (23) | |
|---|---|---|---|
| | Mo (1) | Mo—SiO₂ | SiO₂ (4) |
| Coating A | d = 130 nm | d = 140 nm | d = 50 nm |
| | ff = 1 | ff = linear variation 1→0 | ff = 0 |
| Coating B | d = 100 nm | d = 220 nm | d = 50 nm |
| | ff = 1 | ff = linear variation 1→0 | ff = 0 |

TABLE 2

| | Coating A | Coating B |
|---|---|---|
| α | 0.87 | 0.93 |
| εₙ | 0.059 | 0.099 |
| nₚ | 0.78 | 0.78 |

An analogous optimization proceeding has been carried out for the coating having a double CERMET layer. In this case, the structures have been selected so as to have a photo-thermal conversion efficiency at 580° C. higher than 0.83 and an emissivity lower than 0.07. Among 200 structures identified after this first selection, there have been selected only two structures, the first one with a lowest emissivity (Coating C) and the second one with a highest absorptivity (Coating D).

Table 3 shows the structural parameters of these two coatings, whereas Table 4 shows the photo-thermal parameters. In this case, the coating having the double CERMET layer succeeds in fulfilling the initial requirement and its performance is considerably better than similar structures as are presently known.

TABLE 3

| | | CERMET (2) | CERMET (3) | |
|---|---|---|---|---|
| | Mo (1) | Mo—SiO₂ | Mo—SiO₂ | SiO₂ (4) |
| Coating C | d = 100 nm | d = 45 nm | d = 60 nm | d = 60 nm |
| | ff = 1 | ff = 0.5 | ff = 0.2 | ff = 0 |
| Coating D | d = 100 nm | d = 75 nm | d = 75 nm | d = 70 nm |
| | ff = 1 | ff = 0.5 | ff = 0.2 | ff = 0 |

TABLE 4

| | Coating C | Coating D |
|---|---|---|
| α | 0.90 | 0.93 |
| εₕ | 0.047 | 0.065 |
| nₚₜ | 0.832 | 0.835 |

From a comparison between the coatings A and B having a linear profile and homologous coatings C and D with a double CERMET layer, it is immediately evident that the performance of the latter two coatings is better than that of the former ones. The reason thereof results clearly from FIG. 2, wherein the spectral reflectivity of Coating B with the linear profile CERMET is superimposed on that of Coating D with the double CERMET layer: notwithstanding that the two coatings have the same absorptivity, the emissivities are very different, owing to a minor slope of transition between the solar spectrum zone and the thermal infrared zone in the case of the variable profile CERMET. This result is perfectly congruent with the here-above expressed statements. For greater clarity, in FIG. 2 there is also indicated the reflectivity of an ideal coating at a temperature of 580° C.

A further remark, which can be made with respect to structures with a variable profile CERMET, is that such structures can attain an absorptivity value higher than that of the other structures; in fact among the tested structures there is one having an absorptivity value of 0.948.

Unfortunately, the high absorptivity of this structure is accompanied by a very low photo-thermal conversion efficiency (0.75) due to a high emissivity (0.13). This result is also in accordance with here-above expressed statements.

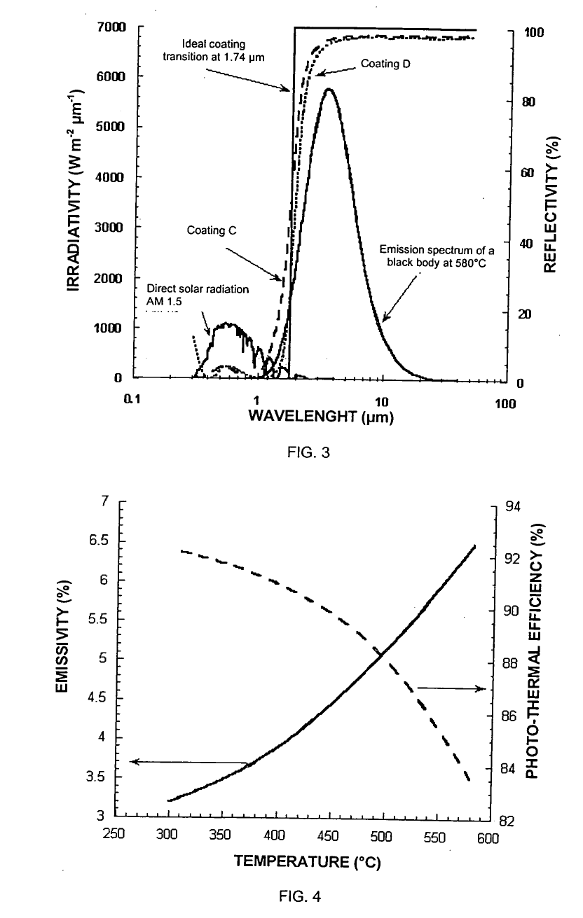

The next step was to carry out a selection between Coating C and Coating D. In FIG. 3 two spectral reflectivity curves are shown, the form of which is similar and near to that of an ideal reflectivity.

Both coatings have been optimized for working at the temperature of 580° C. Thus, at a lower temperature the photo-thermal conversion efficiency thereof is higher, because the absorptivity remains constant but the emissivity decreases. However, since the emissivity of Coating D decreases more quickly than that of Coating C, it is advisable to select Coating D to attain better performance at lower temperatures. FIG. 4 shows the hemispheric emissivity and the photo-thermal conversion efficiency of Coating D as a function of temperature, which varies from 300° C. to 580° C. from the input to output of the linear collector.

To complete the optimization of the coating according to the invention, the evaluation has been performed of the advantage which could have been obtained if, instead of a single coating optimized at the maximum temperature of the linear collector, there would be realized multiple coatings, each optimized for a different temperature which the linear collector reaches along its length. This collector is preferably 600m long and has been divided in three parts: 0-200 m; 200-400 m and 400-600 m, for carrying out a comparison between the photo-thermal performance of Coating D at maximum temperatures of 390, 490 and 580° C. of each sector respectively, and those of three coatings, each optimized for one of the maximum temperatures (first sector at 390° C., second sector at 490° C. and third sector at 580° C.). The following Table 5 shows the absorptivity, emissivity and photo-thermal conversion efficiency of each of the three coatings in comparison with the homologous values of Coating D.

TABLE 5

| | Tₘₐₓ = 390° C. | | Tₘₐₓ = 490° C. | | Tₘₐₓ = 580° C. | |
|---|---|---|---|---|---|---|
| A | Coating D | 0.93 | Coating D | 0.93 | Coating D | 0.93 |
| | Sector 1 | 0.944 | Sector 2 | 0.948 | Sector 3 | 0.93 |
| E | Coating D | 0.038 | Coating D | 0.050 | Coating D | 0.065 |
| | Sector 1 | 0.043 | Sector 2 | 0.063 | Sector 3 | 0.065 |
| N_{pt (%)} | Coating D | 91.1 | Coating D | 88.5 | Coating D | 83.5 |
| | Sector 1 | 92.1 | Sector 2 | 88.7 | Sector 3 | 83.5 |

As can be seen, the difference between the photo-thermal parameters is insufficient to justify employment of different technological processes for realizing coatings individually optimized for the different temperatures reached along the linear collector.

Before concluding, it would be useful to note that the realization of the coating material as disclosed may be performed by one of many known deposition techniques which have been developed for producing thin CERMET layers: including electro-deposition, chemical vapor deposition (CVD), co-evaporation and co-sputtering.

From the commercial point of view, in the last ten years co-sputtering has proved to be the most reliable technique for the realization of ceramic-metallic structures on a large scale with excellent performances and limited production costs. This technique provides the use of magnetron sputtering processes with DC feeding for the molybdenum and RF for the amorphous silicon dioxide.

Thus, at present said deposition technique may be preferred forming the coating material according to the invention.

It could be of interest to note that, bearing in mind that, it have been conceived of solar collector of a concentration system intended to work at temperatures higher than those of the plants until now realized, the choice of the material and the structure design of the coating itself have been driven by the high temperature requirement.

Finally, the particulars of the invention can be summarized in that it consists of a coating, selective to the wavelength of solar radiation, formed by a double CERMET layer 2 and 3 inserted between a reflection metal layer 1 and an antireflection layer 4. The coating has structural and mechanical stability till up to 580° C., has a high absorptivity in the solar radiation range and a low emissivity at 580° C.

Furthermore, the absorption and hemispheric emissivity according to the invention are quite comparable with those of a structure individually optimised along its length for several temperatures reached along the linear collector.

Thus, the surface coating as proposed by the invention assures excellent performances, comparable with those of conventional products, but operable at temperatures never previously reached in linear parabolic systems.

A further novel aspect of the invention consists in the use of molybdenum and amorphous silicon dioxide for realizing surface coatings having such excellent performances up to a temperature of 580° C.

Moreover, a further non-negligible economic advantage of the invention is the limited cost of the material forming the structure: similar structures, as for example these with molybdenum and aluminium may provide a remarkable stability at high temperatures, but with the aluminium cost, which is much higher than that of amorphous silicon dioxide.

The following table shows, in way of example, the thickness α and metal volumetric fractions ff of the coating layers.

TABLE 6

| | CERMET (2) | CERMET (3) | |
|---|---|---|---|
| Mo (1) | Mo—SiO₂ | Mo—SiO₂ | SiO₂ (4) |
| d = 100 nm | d = 75 nm | d = 75 nm | d = 70 nm |
| ff = 1 | ff = 0.5 | ff = 0.2 | ff = 0 |

The present invention has been disclosed and illustrated with reference to a preferred embodiment, but one skilled in the art would be able to introduce functionally and/or technically equivalent changes and/or replacements, without departing from the scope of the present invention.

We claim:

1. A surface coating material for collectors of solar plants, comprising a multi-layer structure comprising a lower metal layer reflecting in the infrared region, an upper antireflection material layer, and an intermediate layer of an amorphous silicon dioxide CERMET having upper and lower layer portions with different metal volumetric fractions, the lower CERMET layer portion having a metal volumetric fraction higher than that of the upper CERMET layer portion.

2. The surface coating of claim 1, wherein the reflecting metal layer has a thickness ranging from 95 to 110 nm; the lower CERMET layer has a thickness ranging from 70 to 80 nm and a volumetric metal fraction from 0.45 to 0.55; the upper CERMET layer has a thickness ranging from 70 to 80 nm and a volumetric metal fraction between 0.15 and 0.25; and the antireflection material layer has a thickness ranging from 65 to 75 nm.

3. A coating material according to claim 1 or 2, wherein the lower metal layer is formed of molybdenum; the lower CERMET layer is formed of a ceramic matrix comprising amorphous silicon dioxide in which molybdenum is dispersed at a volumetric fraction lower than that of an adjacent CERMET layer; and the upper antireflection material layer comprises amorphous silicon dioxide.

4. A coating material according to claim 1 or 2, characterized by a working temperature between 300° and 580° C., whereby a maximum temperature of about 550° C. is attained for a working fluid.

5. A coating material according to claim 1 or 2 wherein the lower metal layer comprises molybdenum and has a thickness of 100 nm; the lower CERMET layer has a thickness of 75 nm and comprises a silicon dioxide matrix in which molybdenum is dispersed at a volumetric fraction of 0.5; the upper CERMET layer has a thickness of 75 nm and comprises a silicon dioxide (SiO₂) matrix, in which molybdenum is dispersed at a volumetric fraction of 0.2; and the upper antireflection material layer comprises amorphous silicon dioxide and has a thickness of 70 nm.

6. A coating material according to claim 1 or 2, characterized in that at a working temperature of 580° C. the coating material has an absorptivity α=0.93; an emissivity εₕ ranging from 0.065 to 0.081; and a photo-thermal conversion efficiency ranging from 0.835 to 0.810.

7. A coating material according to claim 3, characterized in that at a working temperature of 580° C. the coating material has an absorptivity α=0.93; an emissivity εₕ ranging from 0.065 to 0.081; and a photo-thermal conversion efficiency ranging from 0.835 to 0.810.

8. A coating material according to claim 5, characterized in that at a working temperature of 580° C. the coating material has an absorptivity α=0.93; an emissivity εₕ ranging from 0.065 to 0.081; and a photo-thermal conversion efficiency ranging from 0.835 to 0.810.
